(19) United States
(12) Patent Application Publication
(10) Pub. No.: US 2026/0139698 A1
(43) Pub. Date: May 21, 2026

(54) METHOD AND SYSTEM FOR CONNECTING WORKPIECES

(71) Applicant: TAIT TOWERS MANUFACTURING, LLC, Lititz, PA (US)

(72) Inventor: Boris KALABA, Lititz, PA (US)

(21) Appl. No.: 18/955,525

(22) Filed: Nov. 21, 2024

(51) Int. Cl. F16B 5/02

(52) U.S. Cl. CPC F16B 5/02

(57) ABSTRACT

A connector system and method for connecting workpieces according to embodiments of the present disclosure provide a durable and stable connection, including good joint quality and tolerances, even in varied environmental conditions and after repeated assembly and disassembly. The connector system includes a connector pin having a first end having a head portion, a second end having a pin fastener element, and a shank portion extending between the head portion and the pin fastener element. The shank portion includes a first tapered surface. The connector system also includes a plurality of connector members. Each connector member has a second tapered surface at least partially defining a connector opening. The first tapered surface of the connector pin is detachably engageable with a second tapered surface of at least one connector member of the plurality of connector members to form a stable connection.

### FIELD OF THE INVENTION

The present disclosure is generally directed to a structural connector system for connecting workpieces.

### BACKGROUND OF THE INVENTION

There is a general need for connecting two workpieces in many structural systems in civil and mechanical engineering. For example, in the live entertainment industry, multiple pieces of support structures are typically used to support multi-media systems utilized in productions, such as theatrical events or concerts. These connected components suffer from frequent assembly/disassembly, and transportation making it difficult to maintain joint quality and tolerances. The assembly of these types of connected support structures require flexible connections that are durable and stable, even when subjected to the challenging conditions seen in the live entertainment industry.

An example of connection components for use in the live entertainment industry include portable and modular connecting supporting structures for sound, lighting or automation equipment, such as the equipment utilized in touring shows. These types of connections require a structure that provides proper support, stiffness, and ability to permit some relative motion. When being used as part of the support structure for stage system for a touring production, these structures may be subjected to physical strain related to the varied environments and the repeated loading in and loading out of the shows. Structures for connection components may frequently be assembled/disassembled and handled by individuals of varying level of skill and experience. In addition, environmental stressors (for example, wind, rain, high heat, humidity and changes in these conditions) may occur due to local conditions at the venue, exposure during transportation, or other environmental factors to which the components are exposed. Such exposure may, for example, causes the moment-shear interaction between the parts of connection structures, making these components susceptible to damage, particularly at the connecting point. In known systems, in order to provide connection that withstand these stressors, manufacturers have relied upon pin connections inserted through certain connected parts, which may result in instability because of tension and shear failure, for example, due to pin deformation. Therefore, there is an unmet need to provide connections that are resistant to stressors encountered by portable and/or modular support components.

Other known portable and/or modular supporting components for equipment or displays, such as video displays, such as used in touring shows may utilize welded joints. These supporting structures, for example, for temporary outdoor or indoor productions, require a structure that is flexible, adjustable, and portable. When being used as part of a touring production, these structures can be subjected to physical strain related to the varied environments and the setting up and tearing down of the shows. Such exposure may, for example, cause cyclical expansion and contraction of welded support structures, making these components susceptible to damage, particularly at the joints. In known systems, in order to provide joints that withstand these stressors, manufacturers have relied upon welded joints to fabricate these support components, which result in expensive, heavy, and difficult-to-manufacture equipment that require skilled fabricators. In addition, the act of welding itself may have a detrimental effect on the materials being joined. For example, heat exposure, such as heat exposure during welding, in the example of 6061-T6 Aluminum, could reduce strength of the structure up to 50%. Therefore, there is a desire to reduce the reliance on welding when assembling portable and/or modular supporting components

What is needed is a structural system that can provide a durable and stable connection, including good joint quality and tolerances, even in varied environmental conditions and after repeated assembly and disassembly that does not suffer from the drawbacks of the prior art. Other features and advantages will be made apparent from the present specification. The teachings disclosed extend to those embodiments that fall within the scope of the claims, regardless of whether they accomplish one or more of the aforementioned needs.

### SUMMARY OF THE INVENTION

A connector system for connecting workpieces according to embodiments of the present disclosure that provide a durable and stable connection, including good joint quality and tolerances. The connection remains durable and stable even in varied environmental conditions and after repeated assembly and disassembly.

An embodiment of the present disclosure includes a connector pin for use with a connector system for connecting workpieces. The connector pin includes a first end having a head portion, a second end having a pin fastener element, and a shank portion extending between the head portion and the pin fastener element. The shank portion includes a first tapered surface. The first tapered surface is detachably engageable with a second tapered surface of a connector member to form a stable connection.

Another embodiment of the present disclosure includes a connector system for forming a stable connection between workpieces. The connector system includes a connector pin having a first end having a head portion, a second end having a pin fastener element, and a shank portion extending between the head portion and the pin fastener element. The shank portion includes a first tapered surface. The connector system also includes a plurality of connector members. Each connector member has a second tapered surface at least partially defining a connector opening. The first tapered surface of the connector pin is detachably engageable with a second tapered surface of at least one connector member of the plurality of connector members to form a stable connection.

Another embodiment of the present disclosure includes a method of connecting workpieces with a connector system. The method includes providing a connector pin having a first end having a head portion, a second end having a pin fastener element, and a shank portion extending between the head portion and the pin fastener element. The shank portion includes a first tapered surface. A plurality of connector members are provided, where each connector member includes a second tapered surface at least partially defining a connector opening. The connector members are positioned and oriented to align the connector openings of at least two of the connector members. The connector pin is directed into the connector openings of the at least two connector members to engage the first tapered surface with the second tapered surface to form a stable connection.

Other embodiments according to the present disclosure include connector systems having a connecting pin having a pin fastener element having threading to threadingly engage corresponding threading on the connector fastener element.

Other embodiments according to the present disclosure include connector members having a male connector member and a female connector member arranged and disposed to permit engagement of a second tapered surface with a first tapered surface of a connector pin. In addition, the male connector member and the female connector member are further arranged and disposed to permit alignment of the connector openings of the male connector member and the female connector member to permit insertion and engagement of a connector pin.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE FIGURES

FIG. 1 shows a perspective view a connector system to an embodiment of the present disclosure.

FIG. 2 shows a cross-sectional view of a connector system according to an embodiment of the present disclosure.

FIG. 3 shows an exploded, perspective view of a connector system according to an embodiment of the present disclosure.

Wherever possible, the same reference numbers will be used throughout the drawings to represent the same parts.

### DETAILED DESCRIPTION OF THE INVENTION

Unless otherwise explained, all technical and scientific terms used herein have the same meaning as commonly understood by one of ordinary skill in the art to which this disclosure pertains. The singular terms “a,” “an,” and “the” include plural referents unless the context clearly indicates otherwise. Similarly, the word “or” is intended to include “and” unless the context clearly indicates otherwise. The term “includes” means “comprises.” All patents and publications mentioned herein are incorporated by reference in their entirety, unless otherwise indicated. In case of conflict as to the meaning of a term or phrase, the present specification, including explanations of terms, control. Directional terms, such as “upper,” “lower,” “top,” “bottom,” “front,” “back,” “vertical,” and “horizontal,” are used herein to express and clarify the relationship between various elements. It should be understood that such terms do not denote absolute orientation (e.g., a “vertical” component can become horizontal by rotating the device). The materials, methods, and examples recited herein are illustrative only and not intended to be limiting.

The present disclosure includes embodiments including a connector system forming a durable and stable connection, including good joint quality and tolerances that is resistant to varied environmental conditions and repeated assembly and disassembly. An advantage of embodiments according to the present disclosure is that the assembly method and the connector system provide greater stability between connected elements, which are particularly useful for connections with predefined motions, such as supporting structure in stage and lighting support system for live and/or touring entertainment productions. In addition, the connector system may more easily be disconnected without excessive force with readily available hand or power tools.

The present disclosure relates to a connector system and method for connecting workpieces or portions of workpieces together to form a larger, connected system. The connector system includes a connector pin and a plurality of connector members to create a stable connection. By “stable connection” and grammatical variations thereof, as utilized herein, means connection between components, such as connector elements or workpieces, forming a joint that restricts or eliminates the relative motion between joined components and is resistant to environmental conditions and excessive wear and/or damage from repeated assembly and disassembly of the connection.

In particular, the present disclosure relates to a connector system having a connector pin and connector members with corresponding tapered portions. The connector system according to embodiments of the present disclosure also includes a connector element that may be configured to form, for example, a clevis fastener with male and female connector elements. The connector pin and the connector elements may be secured by the pin fastener element and the connector fastener element, for example by threading engagement and/or other connection with or without additional fasteners.

The connector system according to the present disclosure may connect various workpieces. “Workpieces”, and grammatical variations thereof, as utilized herein, include components or subcomponents that when connected together form a larger connected structure or form. For example, workpieces may be connected together into supporting systems in production stage and/or equipment support, work station support, construction safety structures, and/or other load bearing structures. In still other embodiments, connections between workpieces or portions of workpieces may include other structures, such as connections in medical devices, such as artificial joints.

The present disclosure includes embodiments that further enable a method of connecting workpieces with a connector system by providing a connector pin inserted and disengageably engaged with tapered connector openings within a plurality of connector members. The method of connecting workpieces further enforces the connection between the connector pin and the connector members by securing the connector fastener element with the pin fastener element and securing the connector fastener element with the connector members, with threading, fasteners, pinned connections, magnets or other retention and/or securing mechanism.

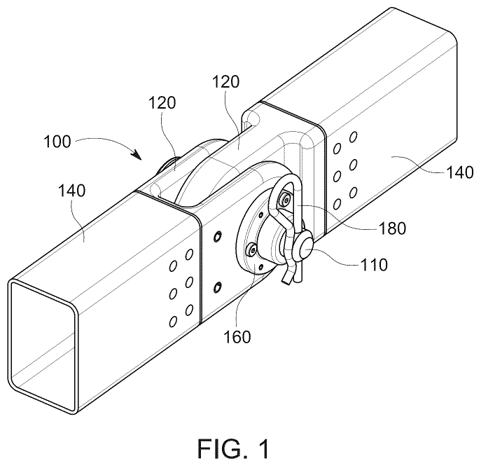

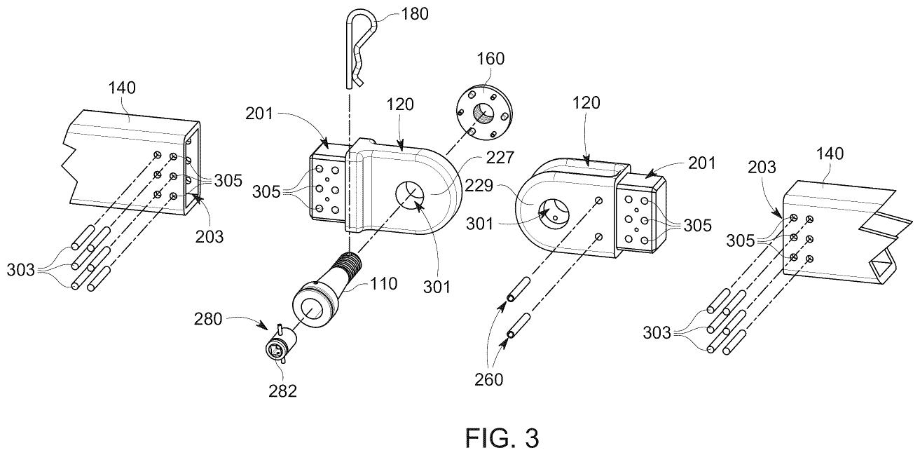

FIG. 1 illustrates a connector system 100 according to the present disclosure. The connector system 100, as shown in FIG. 1, includes workpieces 140 connected with a stable connection. Workpieces 140, as shown in FIG. 1, while not so limited, are portions of tubular bars, which may extend into larger structures (not shown), such as trusses or other support structures. As shown in FIG. 1, the connector system 100 includes a connector pin 110 is positioned and secured within a connector opening 301 (see, for example, FIG. 3) in connector members 120 to form a stable connection between workpieces 140.

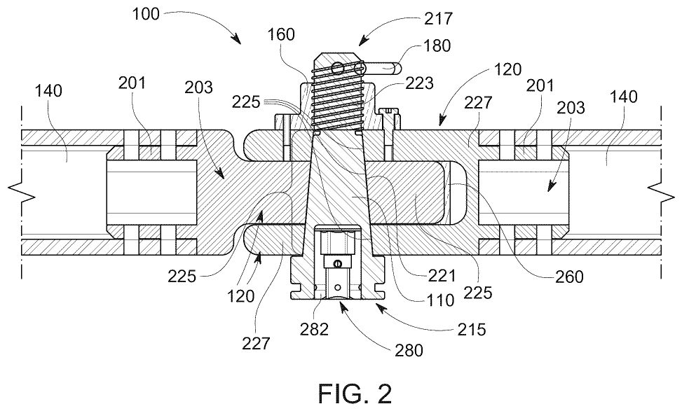

As visible in FIGS. 2 and 3, connector pin 110 includes a first end having a head portion 215, a second end having a pin fastener element 217, and a shank portion 219 extending between the head portion 215 and the pin fastener element 217. The shank portion 219 includes a first tapered surface 221. In the embodiment shown in FIGS. 1-3, the pin fastener element 217 further comprises a threaded element 223. The connection between the connector pin 110 and the connector members 120, in the embodiment shown in FIGS. 1-3, is at least partially secured by the threading on the threaded element 223 of the connector pin 110 threadedly engaged to corresponding threading on the connector fastener element 160. The connector fastener element 160 is positioned on and/or is attached to connector member 120 by any suitable connection method. For example, the connector fastener elements 160 may be attached to connector member 120 by fasteners, pinned connections, adhesive, welding or mechanical interlocking. The embodiment shown in FIGS. 1-3 show the connector fastener element 160 secured by fasteners and pins. In one embodiment, the connector fastener element 160 may be an ACME flange secured to the connector member 120 with fasteners.

The connector pin 110 connector members 120 may be fabricated from any suitable material for forming the connector system. For example, the connector pin 110 and connector members 120 may be formed from metal, such as aluminum or steel.

The connector system 100, as shown in FIGS. 1-3, includes two connector members 120. The connector members 120 are attached to or are integral to workpieces 140. In one embodiment, the connector members 120 are secured to the workpieces 140 by pins 303, such as rolled pins, that are passed through corresponding securing openings 305 in the connector members 120 and the workpiece 140 (see, for example, FIG. 3). However, the present disclosure is not limited to a pinned connection and may include any suitable connection technique, such as fasteners, pinned connections, adhesive, welding or mechanical interlocking. In other embodiments, the connector member 120 and the workpiece 140 may be a unitary component. Each connector member 120 has a second tapered surface 225 at least partially defining a connector opening 301 (see, for example, FIG. 3). The first tapered surface 221 of the connector pin 110 is detachably engageable with a second tapered surface 225 of at least one connector member 120 of the plurality of connector members 120 to form a stable connection (see, for example, FIG. 2). The connector members 120 includes a male connector member 225 and a female connector member 229. The male connector member 225 and female connector member 229 are arranged and disposed to permit engagement of the second tapered surface 225 of the connector members 120 with the first tapered surface 221 of the connector pin 110. The male connector member 225 and the female connector member 229 are further arranged and disposed to permit alignment of the connector openings 301 of the male connector member 225 and the female connector member 229.

In some embodiments, the connector pin 110 is further stabilized by a securing pin 180 inserted through the pin fastener element 217 of connector pin 110 after the connector pin 110 is engaged with the connector member 120. The securing pin 180 is positioned and secured such that the rotation and/or withdrawal of the connector pin 110 is inhibited or prevented.

As visible in FIGS. 2 and 3, connector system 100 includes connector members 120 each having an extension member 201 having a geometry configured to be insertable into receiver slot 203 of workpiece 140 and fixed as part of the workpieces 140. Also, extension member 201 includes securing openings 305 that permit pins 303 to pass into and engage to secure the workpiece 140 to the connector member 120.

As best visible in FIGS. 2 and 3, the plurality of the connector members 120 may include both a male connector member 227 and a female connector member 229. The positioning member 260 shown in FIGS. 2 and 3 is a pin-like structure that is positioned within female connector member 229 to restrict and/or guide positioning of the male connector member 227 with respect to the female connector member 229. However, the positioning member 260 is not so limited and may include any structure that provide restricts or guides positioning of the male connector member 227. This restriction and/or guiding of the positioning permits easier and more reproducible alignment of the connector openings 301 of the connecting members 120 when the male connector member 227 when the male connector member 227 engages the positioning member 260 to allow the connector pin 110 to be inserted and engaged with the connector members 120.

The head portion 215 of the connector pin 110 may include a drive feature 280 to facilitate rotation of the connector pin 110. As shown in FIG. 2 and FIG. 3, the drive feature 280 may include a socket 282 that may be engaged with a corresponding hand or power tool, such as a ratchet or impact drive. In one embodiment, the socket may be a ⅜-inch square ratchet or ⅜-inch impact drive. The drive feature 280 may be secured to the connector pin 110 utilizing any suitable technique. For example, the drive feature 280 may be secured to connector pin 110 by fasteners, pinned connections, adhesive, welding or mechanical interlocking. In other embodiments, the drive feature 280 may be integral to the connector pin 110.

Other embodiments of the present disclosure include a method of connecting workpieces 140. The method includes providing a connector pin 110 having a first end having a head portion 215, a second end having a pin fastener element 217, and a shank portion 219 extending between the head portion 215 and the pin fastener element 217. The shank portion 219 includes a first tapered surface 221. The method further includes providing a plurality of connector members 120. The connector member 120 include connections to workpieces 140 that allow connection of separate workpieces 140 or portions of workpieces 140. Each connector member 120 includes a second tapered surface 225 at least partially defining a connector opening 301. The connector members 120 are positioned and oriented to align connector openings 301 of at least two of the connector members 120. The connector pin 110 is directed into the connector openings 301 of the at least two connector members 120 to engage the first tapered surface 221 with the second tapered surface 225 to form a stable connection.

Another embodiment includes a method where the connector system 100 of the workpieces 140 is adjustable. In one embodiment of the process according to the present disclosure, materials for connector pin 110 and the connector members 120 are weld-free and, in the example of metals, retain their original alloy temper designation. By taper pin engagement in the connections within the connector system 100, it is understood that any metal or non-metal materials with proper strength and weight may be utilized without the thermal effects.

In view of the many possible embodiments to which the principles of the disclosed invention may be applied, it should be recognized that the illustrative embodiments are only preferred examples of the invention and should not be taken as limiting the scope of the invention.

While the exemplary embodiments illustrated in the figures and described herein are presently preferred, these embodiments are offered by way of example only. Accordingly, the present application is not limited to a particular embodiment but extends to various modifications that nevertheless fall within the scope of the appended claims. The order or sequence of any processes or method steps may be varied according to alternative embodiments.

It is important to note that the construction and arrangement of the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

1. A connector pin comprises:
a first end having a head portion;
a second end having a pin fastener element; and
a shank portion extending between the head portion and the pin fastener element, the shank portion including a first tapered surface;
wherein the first tapered surface is detachably engageable with a second tapered surface of a connector member to form a stable connection.

2. The connector pin of claim 1, wherein the pin fastener element further comprises a threaded element.

3. The connector pin of claim 1, wherein the head portion comprise a pin drive feature.

4. The connector pin of claim 3, wherein the drive feature comprises a socket to drive rotation of the connector pin.

5. A connector system comprising:
a connector pin comprising:
a first end having a head portion;
a second end having a pin fastener element; and
a shank portion extending between the head portion and the pin fastener element, the shank portion including a first tapered surface; and
a plurality of connector members, each connector member having a second tapered surface at least partially defining a connector opening;
wherein the first tapered surface of the connector pin is detachably engageable with a second tapered surface of at least one connector member of the plurality of connector members to form a connection.

6. The connector system of claim 5, wherein the connection between the connector pin and the plurality of connector members is further secured through engagement between the pin fastener element of the connector pin and a connector fastener element positioned on at least one connector member of the plurality of connector members.

7. The connector system of claim 6, wherein the pin fastener element includes a threaded member to threadingly engage a corresponding threading on the connector fastener element.

8. The connector system of claim 6, wherein the connector fastener element is further secured to the connector member with one or more fasteners.

9. The connector system of claim 5, wherein the connector members comprise a male connector member and a female connector member, wherein the male connector member and female connector member are arranged and disposed to permit engagement of the second tapered surface with the first tapered surface.

10. The connector system of claim 9, wherein the male connector member and the female connector member are further arranged and disposed to permit alignment of the connector openings of the male connector member and the female connector member.

11. The connector system of claim 5, wherein the connector members further comprise a positioning member to guide the positioning of the male connector member.

12. The connector system of claim 5, wherein at least one of the connector members is secured to a workpiece by a pinned connection.

13. The connector system of claim 5, wherein the head portion includes a socket to drive rotation of the connector pin.

14. The connector system of claim 5, wherein the connector system is weld-free.

15. A method of connecting workpieces with a connector system comprising:
providing a connector pin comprising:
a first end having a head portion;
a second end having a pin fastener element; and
a shank portion extending between the head portion and the pin fastener element, the shank portion including a first tapered surface;
providing a plurality of connector members, each connector member having a second tapered surface at least partially defining a connector opening;
positioning and orienting the connector members to align the connector openings of the at least two connector members; and
directing the connector pin into the connector openings of the at least two connector members to engage the first tapered surface with the second tapered surface to form a stable connection.

16. The method of claim 15, wherein the pin fastener element includes a threaded member to threadingly engage a corresponding threading on the connector fastener element.

17. The method of claim 15, wherein the directing of the connector pin includes inserting the connector pin by rotating the connector pin by engaging and rotating the drive feature of the connector pin.

18. The method of claim 15, wherein the head portion includes a socket for driving the rotation of the connector pin.

19. The method of claim 15, further comprising securing at least one of the connector members to a workpiece with a pinned connection.

20. The method of claim 15, wherein the connector system is weld-free.
